(19) United States
(12) Patent Application Publication
(10) Pub. No.: US 2025/0176759 A1
(43) Pub. Date: Jun. 5, 2025

(54) EXHAUST SYSTEM FOR A COOKING APPLIANCE

(71) Applicant: ANOVA APPLIED ELECTRONICS, INC., San Francisco, CA (US)

(72) Inventors: Håkan Messler, Bromma (SE); Harrison Lees, Waramanga (AU); Jack Xia, Shanghai (CN)

(21) Appl. No.: 18/526,421

(22) Filed: Dec. 1, 2023

(51) Int. Cl. A47J 37/06; A47J 27/04; A47J 36/38

(52) U.S. Cl. CPC A47J 37/0641; A47J 27/04; A47J 36/38; A47J 2027/046

(57) ABSTRACT

A cooking appliance includes a cooking compartment and an exhaust system. The cooking compartment defines a cooking cavity. Moreover, the exhaust system includes a cooling duct for delivering ambient air to the cooking cavity, an exhaust duct for receiving exhaust gas from the cooking cavity and discharging the exhaust gas to an ambient atmosphere, and a fan that is operable to motivate ambient air from the ambient atmosphere through the exhaust system such that a first portion of ambient air flows into the cooling duct, and a second portion of ambient air different from the first portion flows into the exhaust duct.

### TECHNICAL FIELD

The present disclosure relates to an exhaust system for a cooking appliance and, more particularly, to an exhaust system for a steam cooking appliance.

### BACKGROUND

Cooking appliances typically include a cooking cavity and one or more heating elements for heating the cooking cavity. Some cooking appliances also include a steam generating system for generating and delivering steam to the cooking cavity. However, in order to supply steam to the cooking cavity, an equivalent volume of air must leave the cooking cavity to make room for the incoming steam without an increase in pressure. Moreover, it may be desirable to remove steam or heated air from the cooking cavity during or at the end of a cooking operation.

### BRIEF SUMMARY

According to a first aspect, a cooking appliance includes a cooking compartment and an exhaust system. The cooking compartment defines a cooking cavity. Moreover, the exhaust system includes a cooling duct for delivering ambient air to the cooking cavity, an exhaust duct for receiving exhaust gas from the cooking cavity and discharging the exhaust gas to an ambient atmosphere, and a fan that is operable to motivate ambient air from the ambient atmosphere through the exhaust system such that a first portion of ambient air flows into the cooling duct, and a second portion of ambient air different from the first portion flows into the exhaust duct.

According to a second aspect, a cooking appliance includes a cooking compartment and an exhaust system. The cooking compartment defines a cooking cavity. Moreover, the exhaust system includes an exhaust duct for receiving exhaust gas from the cooking cavity and discharging the exhaust gas to an ambient atmosphere, a cooling duct for supplying ambient air to the cooking cavity or the exhaust duct, and a valve assembly configured to regulate airflow from cooling duct into the cooking cavity or the exhaust duct. The valve assembly is operable between a first configuration that allows ambient air within the cooling duct to bypass the cooking cavity and flow into the exhaust duct, and a second configuration that allows ambient air within the cooling duct to flow into the cooking cavity.

### BRIEF DESCRIPTION OF THE DRAWINGS

FIG. 1 is a front perspective view of an example cooking appliance;

FIG. 2 is a front perspective view of the appliance in FIG. 1, but with the door removed and partially cut-away to visualize interior features;

FIG. 3 is a cross-section view of the cooking appliance taken along line 3-3 in FIG. 1;

FIG. 4 is a rear perspective view of the appliance with the outer housing removed to visualize internal components of the appliance;

FIG. 5 is a cross-section view of the cooking appliance taken along line 5-5 in FIG. 1;

FIG. 6 is a left-side view of a valve assembly of the cooking appliance in a first configuration;

FIG. 7 is a left-side view of the valve assembly of the cooking appliance in a second configuration;

FIG. 8 is a section view of the valve assembly and another electronic device of the cooking appliance;

FIG. 9 is a schematic view of a control system of the cooking appliance;

FIG. 10 is an example cooking operation for the cooking appliance;

FIG. 11 is a cross-section view as in FIG. 5, shown while the cooking appliance is performing an initial step 302 of a cooking operation shown in FIG. 10

FIG. 12 is a cross-section view as in FIG. 5, shown while the cooking appliance is performing a humidity-increasing step 308 of the cooking operation in FIG. 10; and

FIG. 13 is a cross-section view as in FIG. 5, shown while the cooking appliance is performing a humidity-decreasing step 310 of the cooking operation in FIG. 10.

### DETAILED DESCRIPTION

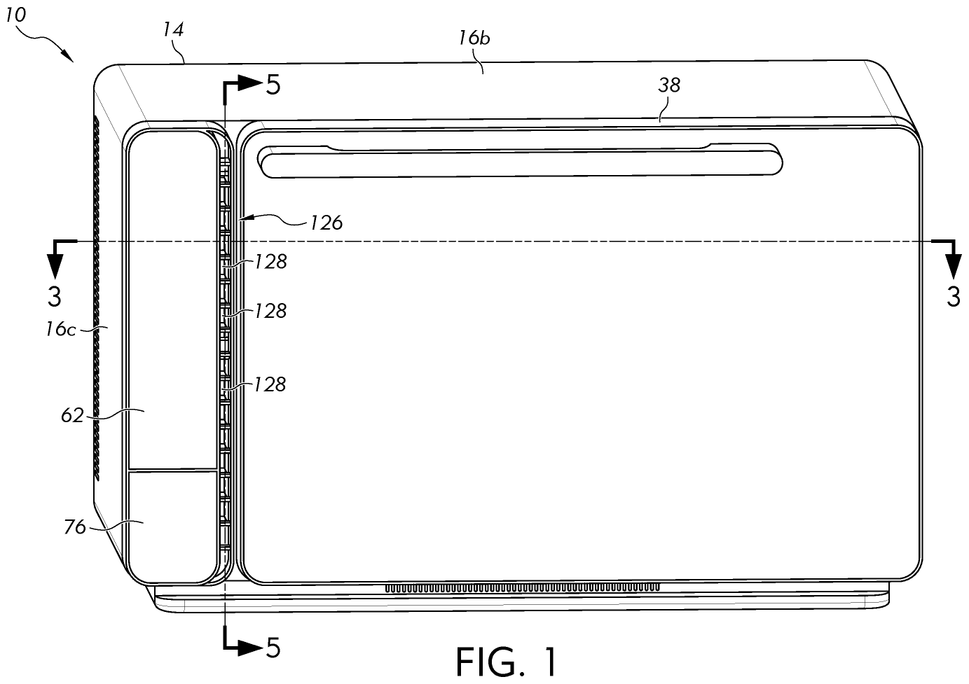

Turning to FIGS. 1-3, an example cooking appliance 10 is shown that corresponds to a countertop oven. The appliance 10 includes a housing 14 with a plurality of walls 16a-f including a bottom wall 16a, a top wall 16b, a left sidewall 16c, a right sidewall 16d, a rear wall 16e, and a front wall 16f. The appliance 10 further includes a cooking compartment 24 within the housing 14 having a plurality of walls 26a-e including a bottom wall 26a, a top wall 26b, a left sidewall 26c, a right sidewall 26d, and a rear wall 26e. The walls 26a-e of the cooking compartment 24 define an cooking cavity 34 with an opening 36 at the front of the compartment 24. Moreover, the appliance 10 includes a door 38 for providing selective access to the cavity 34.

The appliance 10 includes a plurality of heating elements for heating the cooking cavity 34. Specifically, the appliance 10 includes a bake element 42 positioned adjacent to and above the bottom wall 26a of the cooking cavity 34, a broil element 44 positioned adjacent to and below the top wall 26b of the cooking cavity 34, and a convection element 46 positioned adjacent to and behind the rear wall 26e of the cooking cavity 34. The heating elements 42, 44, 46 in the present embodiment are electric-resistive elements that can be energized to produce heat, although one or more of the heating elements 42, 44, 46 may comprise a gas burner in other examples.

The rear wall 26e of the cooking compartment 24 has a plurality of apertures 50 that enable air to flow between the cooking cavity 34 and a rear compartment behind the rear wall 26e that contains the convection element 46. Moreover, the appliance 10 includes a convection fan 52 that is operable to circulate air between the rear compartment and the cooking cavity 34 (e.g., via the apertures 50).

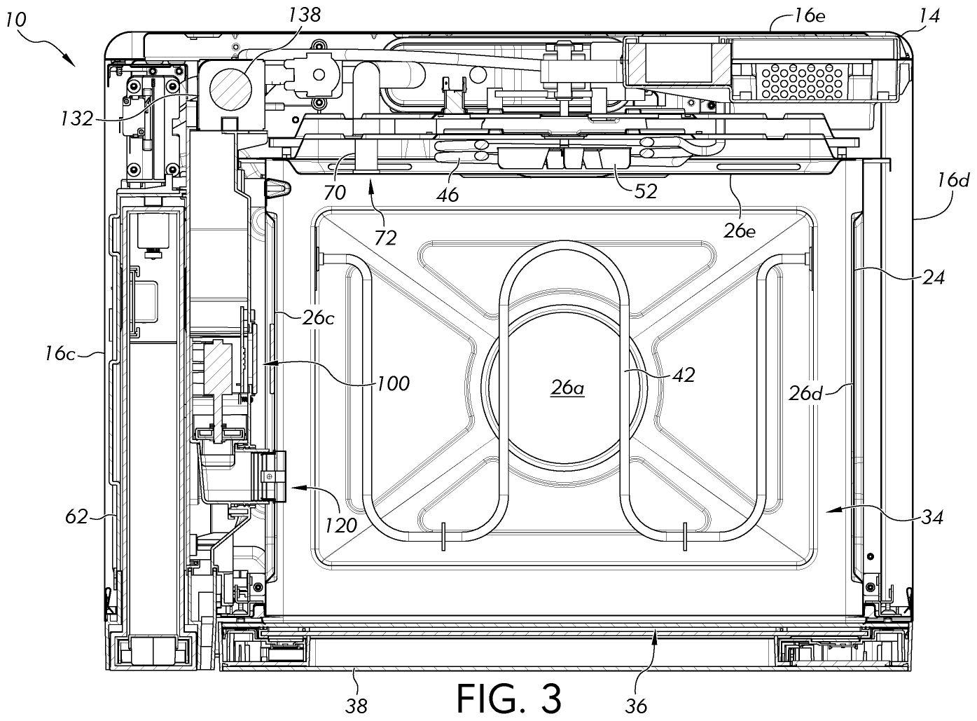

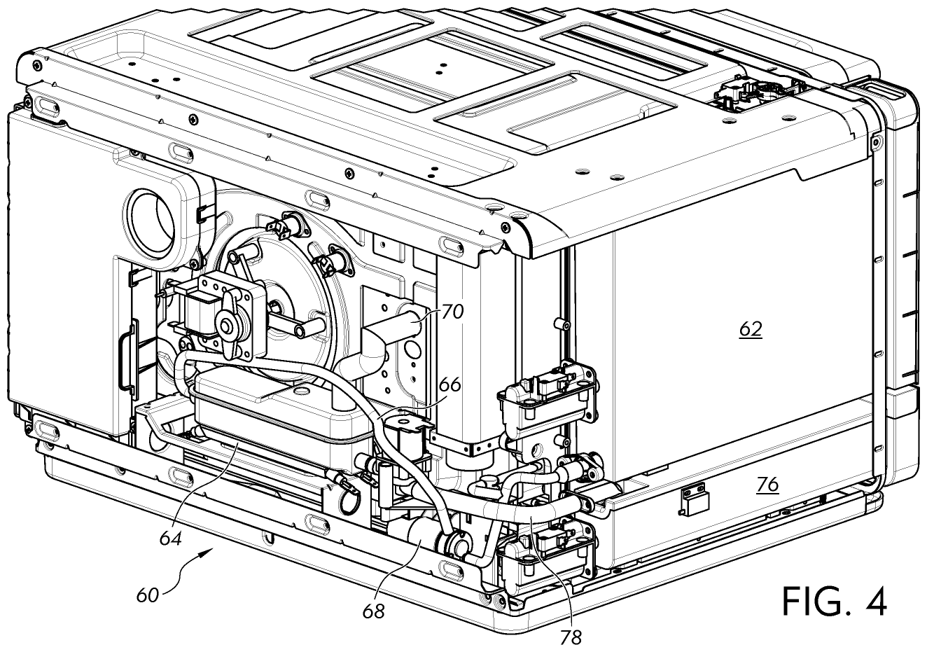

As shown in FIG. 4, the appliance 10 further includes a steam generating system 60 that is operable to generate steam for the cooking cavity 34 during a cooking operation. The steam generating system 60 includes a water supply tank 62 and an electric-resistance boiler 64, which can receive water from the tank 62 and be energized to heat the water and generate steam for the cooking cavity 34. In particular, the boiler 64 can receive water from the tank 62 via a water line 66 using a pump 68. Moreover, steam generated by the boiler 64 is discharged through a steam line 70 into the cooking cavity 34 via a steam inlet 72 (see FIG. 3) defined in the rear wall 26e. The steam generating system 60 also includes a waste water tank 76 below the water supply tank 62, which can collect waste water from the boiler 64 via a waste line 78.

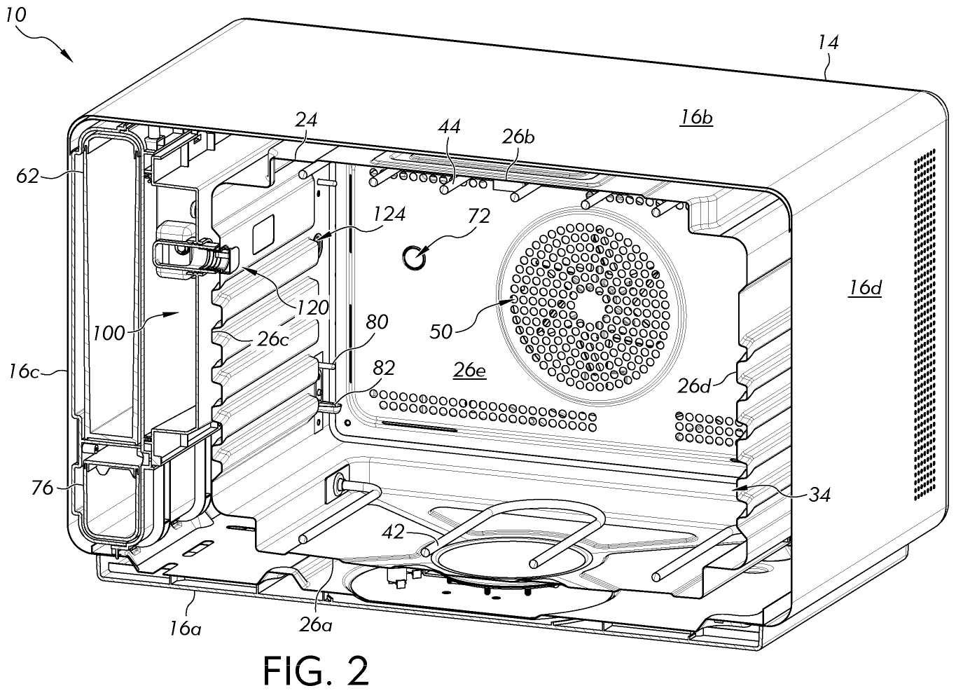

The appliance 10 can further include one or more sensors for detecting a parameter of the cooking cavity 34. For instance, as shown in FIG. 2, the appliance 10 in the present embodiment includes a temperature sensor 80 configured to detect a temperature of the cooking cavity 34, and a humidity sensor 82 configured to detect a humidity (e.g., relative humidity or absolute humidity) of the cooking cavity 34. Moreover, each sensor 80, 82 is configured to provide an electrical output corresponding to its detected parameter.

As discussed further below, the appliance 10 is configured to perform a steam cooking operation that heats and supplies steam to the cooking cavity 34. However, in order to supply steam to the cooking cavity 34, an equivalent volume of air must leave the cooking cavity 34 to make room for the incoming steam without generating an increase in pressure. Moreover, even if steam is not being delivered to the cooking cavity 34, it may be desirable to vent steam or heated air from the cooking cavity 34 during a cooking operation. Accordingly, an exhaust system 100 of the appliance 10 will now be described that can facilitate the venting of exhaust gas (e.g., steam or dry air) from the cooking cavity 34.

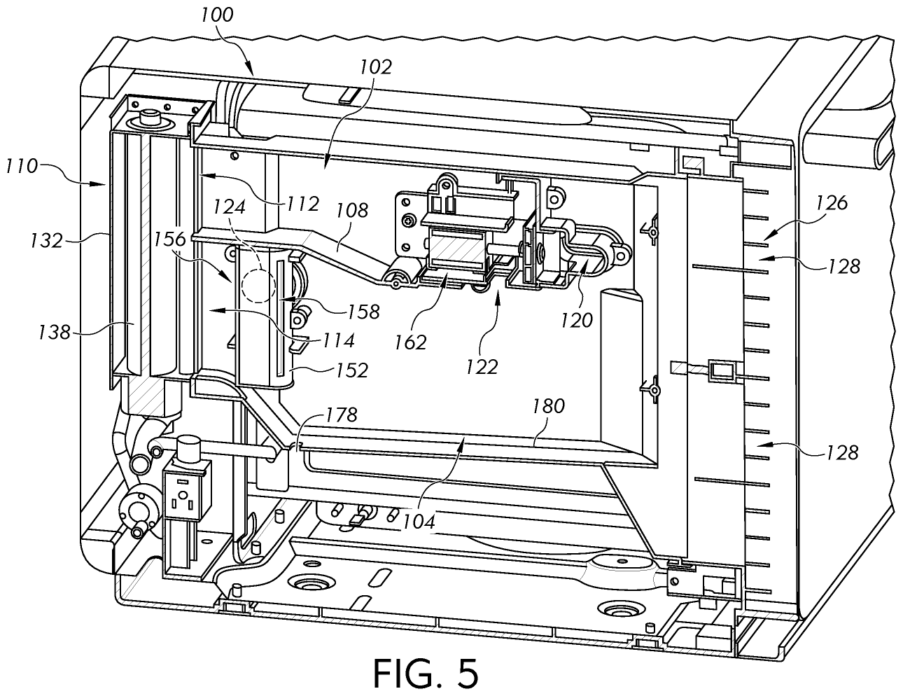

As shown in FIG. 5, the exhaust system 100 includes a cooling duct 102 and an exhaust duct 104 that are vertically stacked along the left side of the appliance 10 such that the cooling duct 102 is arranged above the exhaust duct 104. In particular, the ducts 102, 104 are arranged between the left sidewall 16c of the oven compartment 24 and the tanks 62, 76 of the steam generation system 60 when installed. Moreover, the ducts 102, 104 are defined in part by a common partition wall 108 that extends laterally and separates the interiors of the ducts 102, 104. This stacked configuration of the ducts 102, 104 can provide a compact design for the exhaust system 100 that minimizes the overall size of the appliance 10.

The cooling duct 102 and exhaust duct 104 have respective inlets 112, 114 at their rear ends for receiving ambient air from a fan assembly 110 located at a rear of the appliance 10. The cooling duct 102 further includes a first outlet 120 that penetrates through the side wall 26c of the cooking compartment 24 for delivering air into the cooking cavity 34, and a second outlet 122 for delivering air into the exhaust duct 104 through the partition 108. Moreover, the exhaust duct 104 includes another inlet 124 for receiving exhaust gas (e.g., steam and/or air) from the cooking cavity 34 through the side wall 26c thereof, and an outlet 126 in the form of a plurality of apertures 128 for discharging the exhaust gas to the ambient atmosphere. As shown in FIG. 1, the apertures 128 are configured to discharge exhaust gas through a gap between the door 38 and tanks 72, 76 of the steam generating system 60.

The fan assembly 110 includes a housing 132 and a tangential fan 138 within the housing 132 that is operable to motivate air from the ambient atmosphere around the appliance 10 through the exhaust system 100. In particular, the fan 138 can draw ambient air into the fan assembly 110 and then discharge that ambient air such that a first portion flows into the cooling duct 102 and a second portion (different from the first portion) flows into the exhaust duct 104. As discussed below in further detail, the first portion of ambient air within the cooling duct 102 can flow into the cooking cavity 34 (via the first outlet 120) or into the exhaust duct 104 (via the second outlet 122). Meanwhile, the second portion of ambient air will bypass the cooling duct 102 and cooking cavity 34, such that it flows through the exhaust duct 104 and is discharged through the outlet apertures 128.

The exhaust system 100 further includes a baffle 152 within the exhaust duct 104 that covers the exhaust inlet 124, such that the baffle 152 extends over at least a portion of the inlet 124 in the direction of airflow through the inlet 124. The baffle 152 is essentially box-shaped and has an open end defining an inlet 156 at the rear, the inlet 156 facing toward the fan assembly 110 for receiving ambient air that enters the exhaust duct 104 (via the duct inlet 114). Moreover, the baffle 152 has an outlet 158 at its front end that is smaller than the baffle inlet 156, and optionally is in the shape of an elongated slot. Accordingly, exhaust gases that enter the exhaust duct 104 (via the exhaust inlet 124) can mix with ambient air that enters the baffle's inlet 156, and that mixture can be discharged through the baffle's outlet 158. As discussed further below, this mixing of ambient air with the exhaust gases can minimize superficial mass flow of undiluted steam from exiting the appliance 10 during operation of the exhaust system 100.

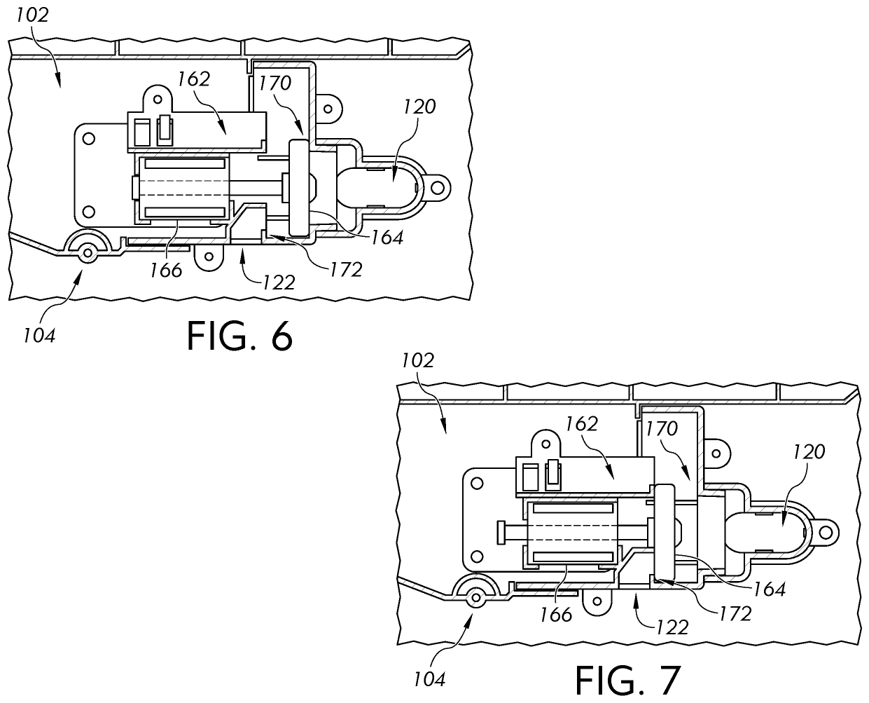

As shown in FIGS. 6 and 7, the exhaust system 100 further includes a valve assembly 162 within the cooling duct 102 that is operable to regulate airflow through the first and second outlets 120, 122 of the cooling duct 102 into the cooking cavity 34 or exhaust duct 104. In the present example, the valve assembly 162 is a gate valve having a movable gate 164 and an electric actuator 166 that can be electrically driven to linearly move the gate 164 between a first configuration and a second configuration.

In the first configuration (shown in FIG. 6), the valve 164 will engage a first seat 170 associated with the first air outlet 120, thereby inhibiting airflow through the first seat 170 to the first air outlet 120 and effectively closing the outlet 120. Notably, the gate 164 will not impede airflow to the second air outlet 122 in the first configuration. Rather, the second air outlet 122 will be open such that air within the cooling duct 102 can be discharged into the exhaust duct 104 via the outlet 122. Preferably, the valve 164 will regulate airflow in the first configuration such that ambient air within the cooling duct 102 is discharged only into the exhaust duct 104.

In the second configuration (shown in FIG. 7), the gate 164 will engage a second seat 172 associated with the second air outlet 122, thereby inhibiting airflow through the second seat 172 to the second air outlet 122 and effectively closing the second air outlet 122. Moreover, the gate 164 will not impede airflow to the first air outlet 120 in the second configuration. Rather, the first air outlet 120 will be open such that air within the cooling duct 102 can be discharged into cooking cavity 34 via the first outlet 120. Preferably, the valve 164 will regulate airflow in the second configuration such that ambient air within the cooling duct 102 is discharged only into the cooking cavity 34.

The valve assembly 162 is thus operable to alternately open the first and second air outlets 120, 122, by linearly moving the gate 164 between the first and second configurations described above. That is, only one outlet 120, 122 will be open in each of the first and second configurations (i.e., the first configuration will close the first outlet 120 and open the second outlet 122, while the second configuration will open the first outlet 120 and close the second outlet 122). Nevertheless, it is to be appreciated that the outlets 120, 122 may both be partially or fully open when the gate 164 is in an intermediate position between the first and second configurations. In the intermediate position, the valve 164 can allow ambient air within the cooling duct 102 to be discharged into both the cooking cavity 34 and exhaust duct 104.

The valve assembly 162 illustrated in the figures is a gate valve having a single gate 164 that can move linearly between first and second configurations to alternately open the first and second outlets 120, 122 of the cooling duct 102. However, the valve assembly 162 may comprise multiple valves in other examples, as well as other valve types/configurations. For instance, the valve assembly 162 may comprise a first valve that is operable to regulate airflow through the first outlet 120, and a second valve that is independently operable to regulate airflow through the second outlet 122. Moreover, the valve assembly 162 may comprise other types of valves such as a butterfly valve or plug valve. The valve assembly 162 can comprise any configuration of one or more valves in which the assembly 162 is operable to regulate airflow through the first and second outlets 120, 122.

As discussed above, the exhaust duct 104 can receive exhaust gases such as steam from the cooking cavity 34 via the exhaust inlet 124, and then discharge those gases to the ambient atmosphere via the exhaust outlet 126. As the steam flows through the exhaust duct 104, it may cool and condense, thereby forming condensation that collects within the exhaust duct 104. Accordingly, the exhaust duct 104 in the present example further includes a drain port 178 for discharging condensate into a discharge line (not shown) that delivers the condensate to the waste water tank 76 of the steam generating system 60, preferably by gravity. Moreover, a lower wall 180 of the exhaust duct 104 is at least partially sloped downward toward the drain port 178. This will facilitate the discharge of condensate from the exhaust duct 104, by guiding condensate toward the drain port 178 via gravity, such that the condensate drains from the exhaust duct 104.

As further discussed above, the cooling duct 102 can receive ambient air from the fan assembly 110, which can flow through the cooling duct 102 into the cooking cavity 34 and/or into the exhaust duct 104 (depending on the configuration of the valve assembly 162). This flow of ambient air through the cooling duct 102 can be useful for various purposes discussed further below. Moreover, in some examples, one or more electronic devices of the appliance 10 can be located along the cooling duct 102, such that ambient air flowing through the cooling duct 102 can fluidically contact and cool the electronic device(s) via convection heat transfer.

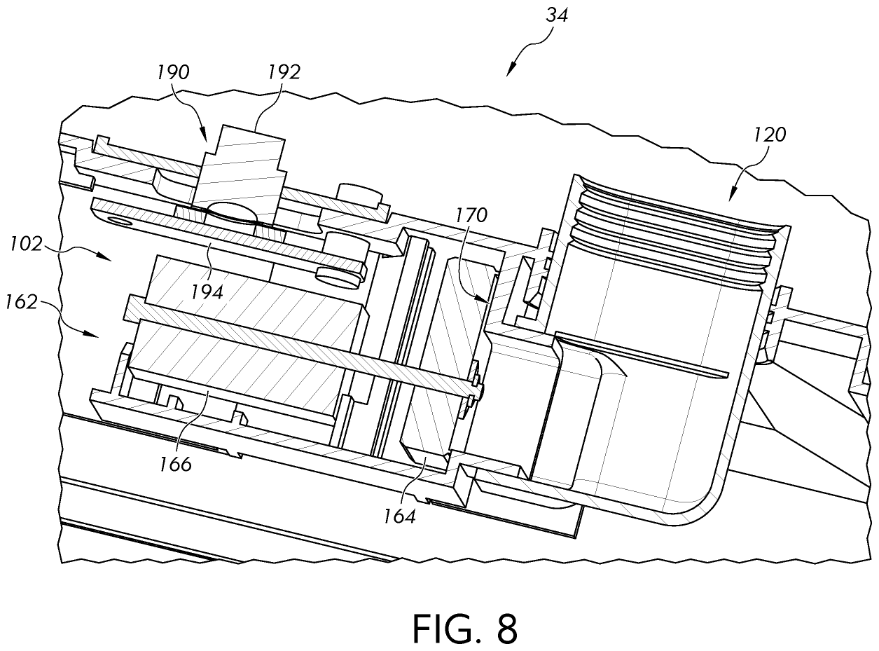

For instance, as shown in FIG. 8, the electronic actuator 166 of the valve assembly 162 is located within the cooling duct 102 and can be cooled by cooling air flowing therethrough. Moreover, the appliance 10 includes an LED device 190 located along and exposed to the cooling duct 102, and which is operable to illuminate the cooking cavity 34. Specifically, the LED device 190 has an LED 192 and associated circuit board 194, which can be electrically energized to generate light that radiates into the cooking cavity 138. The circuit board 194 is arranged entirely within the cooling duct 102, while the LED 192 resides partially within the cooling duct 102 and extends through an associated aperture of the duct 102. As such, cooling air flowing through the cooling duct 102 can fluidically contact the LED 192 and circuit board 194 to cool those components during operation of the appliance 10, via convection heat transfer.

It is to be appreciated that other electronic devices of the appliance 10 can be located along (e.g., within or partially within) the cooling duct 102. For example, an appliance controller or microprocessor may extend along the cooling duct to benefit from convection cooling as described above. Alternatively, such a processor may be mounted to a heat sink having cooling fins that extend within the cooling duct, in order to conduct heat away from the processor, into a convection flow of cooling air within the cooling duct. For the purpose of this disclosure, an electronic device is considered to be located “along” the cooling duct 102 if it resides partially or entirely within the duct 102, or if it defines a wall portion of the duct 102 itself.

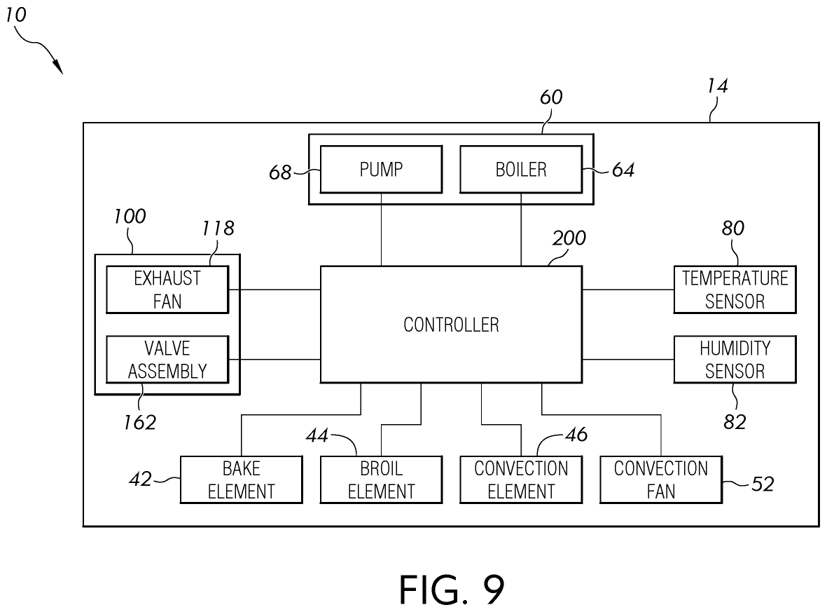

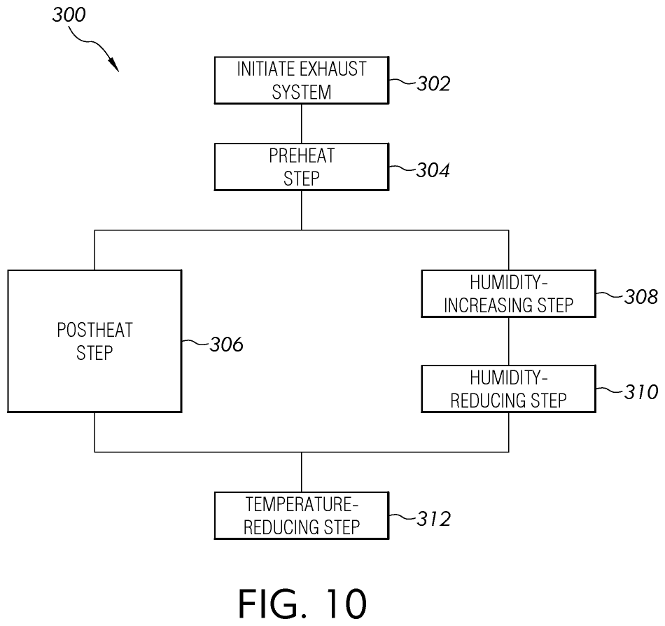

Turning to FIG. 9, the appliance 10 further includes a controller 200 within its housing 14 that is operatively coupled to several devices described above. Specifically, the controller 200 is operatively coupled to the heating elements 42, 44, 46, convection fan 52, steam generating system 60, sensors 80, 82, exhaust fan 138, and valve assembly 162. The controller 200 includes a microprocessor and programmable memory, wherein the microprocessor is configured to control or otherwise communicate with the devices of the appliance 10 operatively coupled thereto. In particular, the microprocessor can control or communicate with the devices to perform one or more cooking operations according to software stored in the microprocessor or its memory and one or more inputs to the controller 200. For instance, an example steam-cooking operation 300 is shown in FIG. 10, which will now be described in further detail.

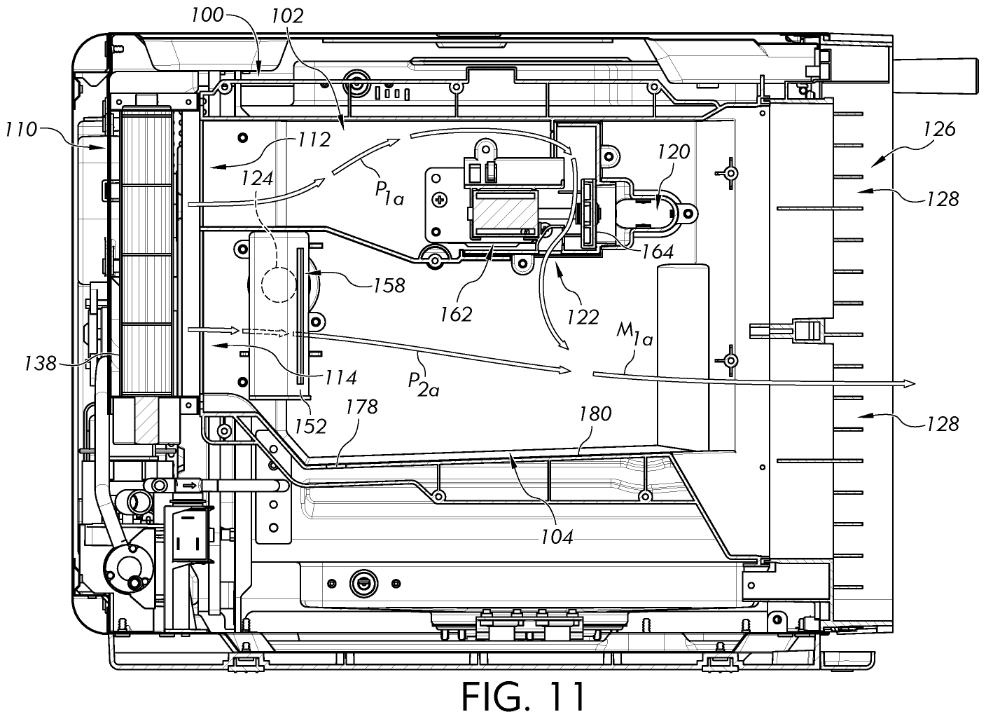

The cooking operation 300 includes an initial step 302 in which the controller 200 initiates the exhaust system 100 by energizing the exhaust fan 138 and operating (e.g., adjusting or maintaining) the valve assembly 160 to assume the first configuration, such that the first outlet 120 is closed and the second outlet 122 is open. As shown in FIG. 11, the initial step 302 will cause a first portion P₁ₐ of ambient (cooling) air to flow into the cooling duct 102, and a second portion P₂ₐ of ambient air to flow into the exhaust duct 104. Moreover, the first portion P₁ₐ will be discharged through the second outlet 122 of the cooling duct 102 into the exhaust duct 104, such that the first and second portions P₁ₐ, P₂ₐ form a mixture Mia that is discharged through the exhaust outlet 126.

By initiating the exhaust fan 138 as described above, a flow of ambient air can be generated in the exhaust system 100 to help cool electronic components located along the cooling duct 102 during the operation. Moreover, the controller 200 can continuously energize the exhaust fan 138 for the remainder of the operation 300, while adjusting the valve assembly 160 at various steps described further below.

The cooking operation 300 next includes a first temperature-regulating step 304 (e.g., “preheat”) in which the controller 200 regulates cooking cavity temperature by operating one or more of the heating elements 42, 44, 46 and convection fan 52 based on a predetermined target temperature T₁ (stored in the controller's memory) and feedback from the temperature sensor 80. For example, the controller 200 can continuously energize all three elements 42, 44, 46 and the convection fan 52 until the output of the temperature sensor 80 indicates that the temperature of the cooking cavity 34 is equal to or greater than the target temperature T₁.

Upon completion of the preheating step 304, the cooking operation 300 can, e.g., initiate a second temperature-regulating step 306 (e.g., “postheat”) in which the controller 200 regulates cooking cavity temperature by operating one or more of the heating elements 42, 44, 46 and convection fan 52 based on a predetermined target temperature T₂ (stored in the controller's memory) and feedback from the temperature sensor 80. For example, the controller 200 can monitor the output of the temperature sensor 80 (which indicates oven temperature) and operate the convection element 46 according to a duty cycle (e.g., 30 sec ON, 30 sec OFF) to maintain oven temperature about the target temperature T₂. In particular, the controller 200 can regulate performance of the duty cycle based on hysteresis or PID control to maintain oven temperature about the target temperature T₂ (which may be equivalent to or different from the target temperature T₁ of the preheating step 304). Moreover, the controller 200 can continuously energize the convection fan 52 for the entire postheat step 306.

The cooking operation 300 may also include a humidity-increasing step 308 in which the controller 200 regulates operation of the steam generating system 60 to increase humidity within the cooking cavity 34. In particular, the controller 200 will compare the output of the humidity sensor 82 to a predetermined humidity threshold H₁ (stored in the controller's memory) and operate the steam generating system 60 based on the comparison. If the output is below the humidity threshold H₁, the controller 200 will operate the pump 68 to deliver water from the water supply tank 62 to the boiler 64. Moreover, the controller 200 will energize the boiler 64 to heat the water and generate steam, which will be delivered to the cooking cavity 34 via the steam inlet 72. The controller 200 can continue operating the steam generating system 60 accordingly until the output of the humidity sensor 82 is equal to or above the humidity threshold H₁, at which point the controller 200 can cease operation of the steam generating system 60.

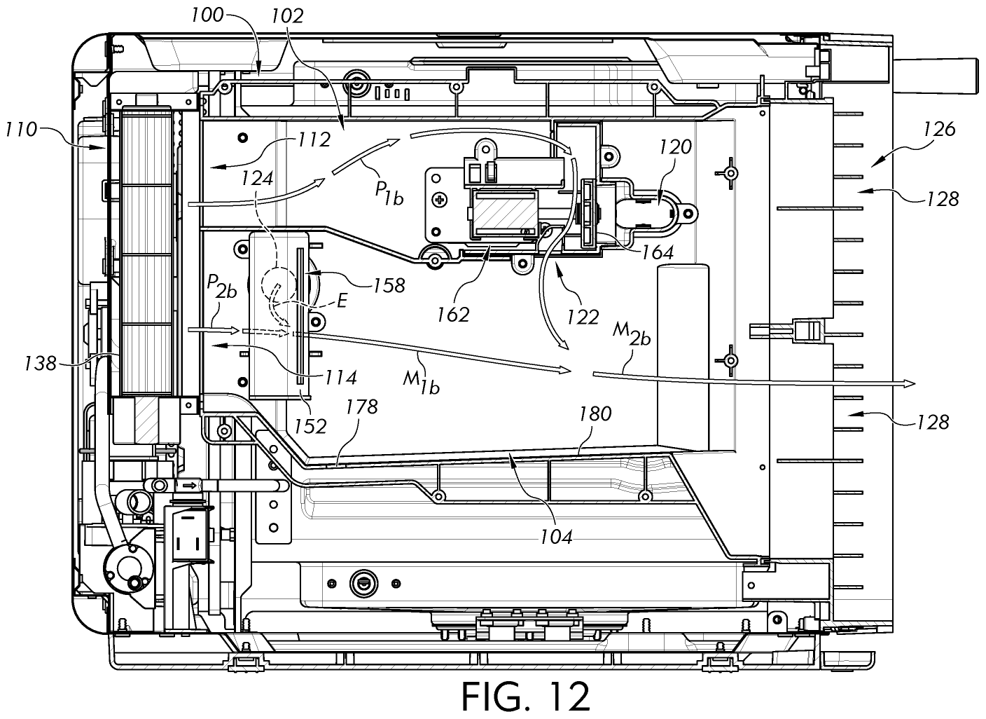

As steam enters the cooking cavity 34 during the humidity-increasing step 308, an equivalent volume of air within the cooking cavity 34 must be discharged from the cavity 34 to make room for the incoming steam without building pressure. Accordingly, the controller 200 will also regulate operation of the exhaust system 100 during the humidity-increasing step 308 to generate an airflow through the exhaust system 100 that facilitates venting of air from the cavity 34. Specifically, as shown in FIG. 12, the controller 200 will continuously energize the exhaust fan 138 during the humidity-increasing step 308 such that first and second portions P_{1b}, P_{2b} of ambient air respectively flow into the cooling duct 102 and exhaust duct 104. Moreover, the second portion P_{2b} of ambient air flowing through the exhaust duct 104 will help draw exhaust E (e.g., steam or air) from the cooking cavity 34 into the exhaust duct 104 (through the inlet 124) via a Venturi effecti, such that it combines with the second portion P_{2b} to form a first mixture M_{1b}. Meanwhile, the first portion P_{1b} of ambient air will flow through the cooling duct 102 into the exhaust duct 104 (via the second outlet 122), such that the first portion P_{1b} and first mixture M_{1b} eventually combine to form a second mixture M_{2b} that is discharged through the exhaust outlet 126.

In the present example, the humidity-increasing step 308 is initiated simultaneously with the postheat step 306 in response to completion of the preheat step 304. However, the humidity-increasing step 308 may be initiated during the preheat step 304 or after initiation of the postheat step 306 in some examples. Moreover, the humidity-increasing step 308 can be performed a single time during the cooking operation 300, or the controller 200 can continuously monitor the output of the humidity sensor 82 and repeatedly perform the humidity-increasing step 308 whenever the output is below the humidity threshold H₁.

In some cases, it may be desirable to decrease temperature and/or humidity within the cooking cavity 34 during the cooking operation 300. Thus, the cooking operation 300 can include one or more exhaust steps that regulate the exhaust system 100 to remove steam or heated air from the cooking cavity 34.

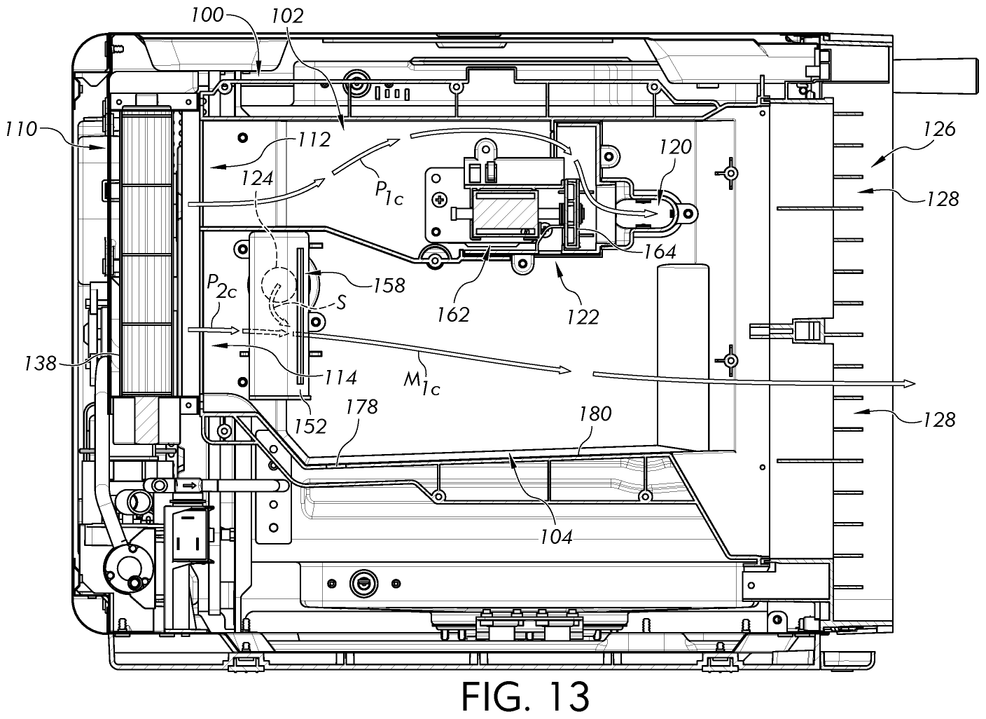

For instance, the cooking operation 300 can include an exhaust step in the form of a humidity-reducing step 310, wherein the controller 200 regulates the exhaust system 100 to generate an airflow (shown in FIG. 13) that reduces humidity of the cooking cavity 34. Specifically, the controller 200 can continuously energize the exhaust fan 138 for the entire duration of the humidity-reducing step 310. Moreover, the controller 200 can operate (e.g., maintain or adjust) the valve assembly 162 to assume the second configuration (i.e., such that the first outlet 120 is open and the second outlet 122 is closed). This will cause first and second portions P_{1c}, P_{2c} of ambient air to flow respectively into the cooling duct 102 and exhaust duct 104. The first portion Pie of ambient air will enter the cooking cavity 34 (via the first outlet 120), thereby displacing and diluting steam therein, wherein a resulting steam/air mixture S will be discharged from the cooking cavity 34 into the exhaust duct 104 (via the inlet 124). Moreover, the discharged steam/air mixture S will combine with the second portion P₂ₑ of ambient air in the exhaust duct 104 to form a mixture Mie that is discharged through the exhaust outlet 126.

Assuming the ambient air that enters the cooking cavity 34 during the humidity-reducing step 310 (e.g. via inlet 120) is relatively dry compared to the steam/air mixture S that exits the cooking cavity 34 through outlet 124, this will cause the humidity of the cooking cavity 34 to drop. Moreover, by diluting the steam/air mixture S that enters the exhaust duct 104 with the second portion P_{2c} of ambient air flowing therethrough, moisture condensation within that duct 104 is minimized, thus reducing the frequency with which the waste water tank 62 must be drained. The humidity content of exhausted air exiting from the front of the appliance 10 also is reduced, such that condensation at that location, or on the countertop, etc. near there, also is minimized.

The controller 200 can maintain the valve assembly 162 in the second configuration (thus leaving open inlet 120) until a given condition is satisfied. For instance, that condition may be a predetermined amount of time, or an output of the humidity sensor 82 being equal to or below a humidity threshold H₂ (stored in the controller's memory). In response to this condition, the controller 200 can then operate the valve assembly 162 to assume the first configuration, which will close the first outlet 120 and inhibit further ambient air from entering the cooking cavity 34 and reducing its humidity.

The humidity-reducing step 310 can be performed at any point during the cooking operation 300. For instance, the humidity-reducing step 310 can be performed upon completion of the humidity-increasing step 308, or once a predetermined amount of time has lapsed since initiation of the postheat step 306. Alternatively, the humidity-reducing step 310 can be performed in response to some other condition such as completion of the postheat step 306.

The cooking operation 300 may also include an exhaust step in the form of a temperature-reducing step 312, which operates the exhaust system 100 similar to the humidity-reducing step 310, but this time for the purpose of reducing the temperature of the cooking cavity 34 by introducing ambient air. Specifically, the controller 200 can continuously energize the exhaust fan 138 for the entire duration of the temperature-reducing step 312. Moreover, the controller 200 can operate (e.g., adjust or maintain) the valve assembly 162 to assume the second configuration, such that the first outlet 120 is open and the second outlet 122 is closed. This will generate an airflow similar to that shown in FIG. 13 for the humidity-reducing step 310, such that ambient air within the cooling duct 102 enters the cooking cavity 34 (via the first outlet 120). The entering ambient (cooler) air will mix with the heated air/steam within the cooking cavity, diluting it and reducing the overall air temperature therein, as well as displacing an equivalent volumetric flow rate of air/steam to be discharged into the exhaust duct 104 via outlet 124, thereby reducing temperature within the cooking cavity 34.

The controller 200 can maintain the valve assembly 162 in the second configuration until a given condition is satisfied, which again can be the passage of a predetermined amount of time. Alternatively, the condition could be the output of the temperature sensor 80 being equal to or below a cooling threshold Tc (stored in the controller's memory). In response to the condition, the controller 200 can operate the valve assembly 162 to assume the first configuration. The first configuration of the valve assembly 162 will close the first outlet 120 of the cooling duct 102, thereby inhibiting further ambient air from entering the cooking cavity 34 and reducing its temperature.

The temperature-reducing step 312 can be performed at any point during the cooking operation 300 to reduce oven temperature as desired. For instance, the temperature-reducing step 312 can be performed upon completion of the postheat step 306 to thereby cool the cooking cavity 34 before a user opens the door 38 of the appliance 10 to remove a cooked food item. Moreover, upon completion of the temperature-reducing step 312, the controller 200 can de-energize the exhaust fan 138 and cease the cooking operation 300.

As will be appreciated, a principal difference between a humidity-reducing step 310 and a temperature-reducing step 312 as performed using the exhaust system 100 can depend on whether temperature or humidity measured within the cavity will supply an endpoint for the step. Indeed, such step(s) can be performed wherein the controller 200 will accept and analyze both temperature- and sensor data, in order to maintain or adjust the cooking environment within the cavity 34 to achieve desired values of both temperature and humidity. For example, if it is desirable to reduce the temperature quickly using a temperature-reducing step 312 but it is not desired to concomitantly reduce humidity, then the boiler 64 can be operated simultaneously with the temperature-reducing step 312 to introduce fresh steam to the cavity 34 even as air therein is being vented to reduce temperature. Data from the humidity sensor 82 can inform when it will be appropriate during such a step to continue, cease, or cycle boiler operation to introduce steam.

The exhaust system 100 as described above can thus be operated to serve various functions for the appliance 10 such as, for example, cooling electrical devices located along the cooling duct 102, removing air within the cooking cavity 34 that is displaced from incoming steam, and reducing temperature and/or humidity within the cooking cavity 34. As noted above, the exhaust duct 104 of the system 100 has a baffle 152 that can receive ambient air from the fan assembly 110 (via the baffle inlet 156) and exhaust from cooking cavity 34 (via the exhaust inlet 124). The baffle 152 minimizes superficial mass flow of undiluted steam from exiting the appliance 10, by ensuring sufficient mixing of steam and ambient air within the baffle 152 before exiting through the apertures 128 of the exhaust duct 104. This minimizes visible steam exiting the outlet, which may be unsightly and also increase the potential for visible condensation.

Illustrative embodiments have been described, hereinabove. It will be apparent to those skilled in the art that the above apparatuses and methods may incorporate changes and modifications without departing from the general scope of this disclosure. The disclosure is intended to include all such modifications and alterations disclosed herein or ascertainable herefrom by persons of ordinary skill in the art without undue experimentation.

What is claimed is:

1. A cooking appliance comprising:
a cooking compartment that defines a cooking cavity;
an exhaust system comprising:
a cooling duct for delivering ambient air to the cooking cavity,
an exhaust duct for receiving exhaust gas from the cooking cavity and discharging the exhaust gas to an ambient atmosphere, and
a fan that is operable to motivate ambient air from the ambient atmosphere through the exhaust system such that a first portion of ambient air flows into the cooling duct, and a second portion of ambient air different from the first portion flows into the exhaust duct.

3. The cooking appliance according to claim 1, wherein the cooling duct and exhaust duct are vertically stacked such that one of the cooling duct and exhaust duct is arranged above the other.

4. The cooking appliance according to claim 1, wherein the cooling duct and the exhaust duct share a common partition wall that separates an interior of the cooling duct from an interior of the exhaust duct.

5. The cooking appliance according to claim 1, further comprising an electronic device located along the cooling duct, such that air within the cooling duct will fluidly contact and be effective to cool the electronic device via convection heat transfer.

6. The cooking appliance according to claim 1, wherein the exhaust duct includes:
an air inlet for receiving the second portion of ambient air,
an exhaust inlet for receiving the exhaust gas from the cooking cavity, and
an exhaust outlet for discharging the exhaust gas to the ambient atmosphere outside of the cooking appliance.

7. The cooking appliance according to claim 6, further including a baffle within the exhaust duct that covers the exhaust inlet, the baffle defining a baffle inlet configured to receive at least part of the second portion of ambient air that enters through the air inlet of the exhaust duct, and a baffle outlet that is smaller than the baffle inlet.

8. The cooking appliance according to claim 1, wherein the exhaust duct includes a drain port for discharging condensate.

9. The cooking appliance according to claim 8, wherein the drain port is at or adjacent to a lower wall of the exhaust duct, the lower wall being sloped downward toward the drain port.

10. The cooking appliance according to claim 1, wherein:
the cooling duct includes an air inlet for receiving the first portion of ambient air, a first outlet for discharging the first portion of ambient air into the cooking cavity, and a valve assembly that is operable to regulate airflow through the first air outlet.

11. The cooking appliance according to claim 10, wherein:
the cooling duct includes a second outlet for discharging the first portion of ambient air into the exhaust duct, and
the valve assembly is operable to regulate airflow through the second outlet.

12. The cooking appliance according to claim 11, wherein the valve assembly is operable to alternately open the first and second outlets.

13. The cooking appliance according to claim 12, wherein the valve assembly includes a gate valve comprising a gate that is movable to alternately open the first and second outlets.

14. The cooking appliance according to claim 10, further comprising:
one or more heating elements for heating the cooking cavity,
a controller operatively coupled to the valve assembly and the one or more heating elements, wherein the controller is configured to perform a cooking operation that regulates operation of the exhaust system and the one or more heating elements.

15. The cooking appliance according to claim 14, wherein the cooking operation includes an exhaust step in which the controller will energize the fan and operate the valve assembly to assume a configuration in which the first outlet is open.

16. The cooking appliance according to claim 15, wherein in response to a condition being satisfied during the exhaust step, the controller will operate the valve assembly to assume a configuration in which the first outlet is closed.

17. The cooking appliance according to claim 16, further comprising a sensor configured to detect a parameter of the cooking cavity and to provide an output corresponding to the detected parameter, wherein the controller is configured to perform the exhaust step based on the output of the sensor.

18. The cooking appliance according to claim 17, wherein the parameter is a temperature or humidity of the cooking cavity.

19. The cooking appliance according to claim 17, wherein said condition comprises the parameter being equal to or less than a predetermined threshold.

20. The cooking appliance according to claim 15, wherein:
the cooking operation includes a temperature-regulating step in which the controller will regulate temperature of the cooking cavity by regulating the one or more heating elements, and
the controller will perform the exhaust step in response to completion of the temperature-regulating step.

21. The cooking appliance according to claim 14, said cooking operation comprising simultaneous regulation of both temperature and humidity within the oven cavity based on respective setpoints or thresholds thereof, via operation of both the boiler and the exhaust system by the controller.

22. A cooking appliance comprising:
a cooking compartment that defines a cooking cavity; and
an exhaust system comprising:
an exhaust duct for receiving exhaust gas from the cooking cavity and discharging the exhaust gas to an ambient atmosphere,
a cooling duct for supplying ambient air to the cooking cavity or the exhaust duct, and
a valve assembly configured to regulate airflow from cooling duct into the cooking cavity or the exhaust duct, wherein the valve assembly is operable between a first configuration that allows ambient air within the cooling duct to bypass the cooking cavity and flow into the exhaust duct, and a second configuration that allows ambient air within the cooling duct to flow into the cooking cavity.

23. The cooking appliance according to claim 22, wherein the first configuration allows ambient air within the cooling duct to flow only into the exhaust duct, and the second configuration allows ambient air within the cooling duct to flow only into the cooking cavity

24. The cooking appliance according to claim 23, said valve assembly being further operable in an intermediate configuration that allows ambient air within the cooling duct to flow into both the exhaust duct and the cooking cavity.
